(19) United States
(12) Patent Application Publication
(10) Pub. No.: US 2015/0143956 A1
(43) Pub. Date: May 28, 2015

(54) TOOL

(71) Applicant: William J. Bober, Cary, NC (US)

(72) Inventor: William J. Bober, Cary, NC (US)

(21) Appl. No.: 14/091,541

(22) Filed: Nov. 27, 2013

(51) Int. Cl. B67B 7/14; B67B 7/16

(52) U.S. Cl. CPC B67B 7/14; B67B 7/16
USPC 81/3.55

(57) ABSTRACT

A tool is described for removing a lid from a container. The tool comprises a rigid elongated body member having a first end, a second end, and a longitudinal axis, the first end of the body member having an irregular perimeter. A flange has a proximal end and a distal end, the proximal end of the flange being attached to the second end of the body member at a predetermined angle with respect to the longitudinal axis of the body member. A curved tip is formed at the distal end of the flange, the curved tip terminating in a free distal edge. The tip of the tool is adapted to engage the lid of the container for repeatedly applying leverage force to the lid for prying the lid from the container.

### BACKGROUND

A hand tool is described and, more particularly, a hand tool used for removing covers or lids from containers.

Some containers have removable lids for sealing a container opening. The rim of the container defines a generally U-shaped channel impressed in an upper surface about the periphery of the container. The outermost portion of the rim defining the channel terminates at an outwardly extending bead extending around the entire periphery of the upper end of the container. The lids comprise a continuous, circular downwardly extending flange and adjacent lip along its outer periphery. The channel of the container is configured to receive the flange of the lid for sealing the container. When the lid is sealed on the container, there is a gap between the lip of the lid and the perimeter of the top edge of the rim of the container. This container and lid configuration is commonly associated with paint cans.

Various types of leverage devices or “openers” have been proposed for removing lids from containers, such as paint cans. A typical opener includes a tip that is inserted into the space between the lip of the lid and the rim of the container. Upon insertion of the tip, the user uses the tool as a lever and the rim of the container as a fulcrum to impart a generally upward force on the lip of the lid. As the opener is pushed downwardly in a radial direction relative to the container, an upward leverage force is applied to the lip of the lid creating a slight gap between the lip and the rim of the container. Subsequently, the opener is moved along the circumference of the container while the tip of the opener remains in the gap. A similar leverage force is then applied to further open the gap. The user of the opener repeats these steps along the circumference of the container until the lid is completely separated from the container.

There is a need for a tool for use in removing a lid from a container that is more efficient and easier to use.

### SUMMARY

A tool is described for removing a lid from a container. The tool comprises a rigid elongated body member having a first end, a second end, and a longitudinal axis, the first end of the body member having an irregular perimeter. A flange has a proximal end and a distal end, the proximal end of the flange being attached to the second end of the body member at a predetermined angle with respect to the longitudinal axis of the body member. A curved tip is formed at the distal end of the flange, the curved tip terminating in a free distal edge. The tip of the tool is adapted to engage the lid of the container for repeatedly applying leverage force to the lid for prying the lid from the container.

A combination is also described, including a tool comprising a rigid elongated body member having a first end, a second end, and a longitudinal axis, the first end of the body member having an irregular perimeter. A flange has a proximal end and a distal end, the proximal end of the flange being attached to the second end of the body member at a predetermined angle with respect to the longitudinal axis of the body member. A curved tip is formed at the second end of the flange and having a distal edge oriented in a direction substantially perpendicular to a plane defined by the longitudinal axis of the member. A handle member has an opening dimensioned to non-rotatably receive a portion of the first end of the body member. In use, the tool is secured in the opening of the handle and the tip of the tool is adapted to engage the lid of the container such that the combined handle and tool repeatedly apply leverage force to the lid for prying the lid from the container.

### BRIEF DESCRIPTION OF THE DRAWINGS

FIG. 1 is a top perspective view of an embodiment of a tool for removing a lid of a container.

FIG. 2 is a bottom perspective view of the tool as shown in FIG. 1.

FIG. 3 is a top plan view of the tool as shown in FIG. 1.

FIG. 4 is a bottom plan view of the tool as shown in FIG. 1.

FIG. 5 is a left side elevation view of the tool as shown in FIG. 1.

FIG. 6 is a front elevation view of the tool as shown in FIG. 1.

FIG. 7 is a rear elevation view of the tool as shown in FIG. 1.

FIG. 8 is a top perspective view of another embodiment of a tool for removing a lid of a container.

FIG. 9 is a bottom perspective view of the tool as shown in FIG. 8.

FIG. 10 is a top perspective view of a third embodiment of a tool for removing a lid of a container.

FIG. 11 is a bottom perspective view of the tool as shown in FIG. 10.

FIG. 12 is an exploded perspective view of the tool as shown in FIG. 10 and an adaptor.

FIG. 13 is a side elevation view of the tool as shown in FIG. 10 in a first position for removing a lid of a container.

FIG. 14 is a side elevation view of the tool as shown in FIG. 13 in a second position for removing a lid of a container.

### DESCRIPTION

Certain terminology is used herein for convenience only and is not to be taken as a limitation on the invention. For example, words such as “upper,” “lower,” “left,” “right,” “horizontal,” “vertical,” “upward,” and “downward” merely describe the configuration shown in the FIGs. Indeed, the components may be oriented in any direction and the terminology, therefore, should be understood as encompassing such variations unless specified otherwise.

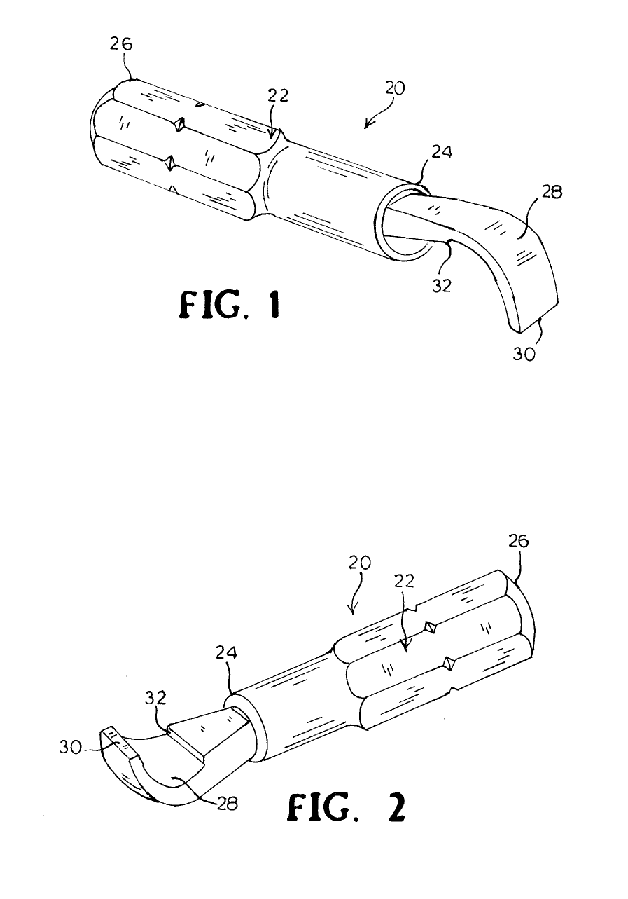

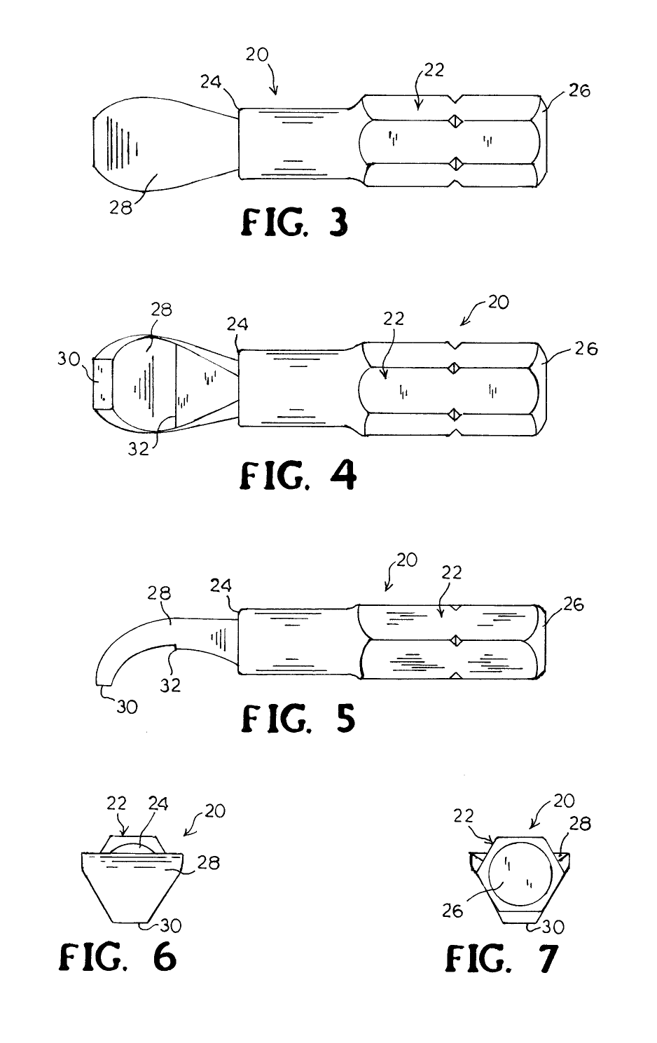

Referring now to the drawings, wherein like reference numerals designate corresponding or similar elements throughout the several views, an embodiment of a tool for removing a lid of a container is shown in FIGS. 1-7 and generally designated at 20. The tool 20 comprises a generally elongated body 22 having a first distal end 24 and a second proximal end 26. The distal end 24 of the body 22 has a substantially straight portion terminating in an arcuate tip 28. The end 30 of the tip 28 comprises a relatively sharp edge extending substantially perpendicularly to the longitudinal axis of the body 22 of the tool 20. The tip 28 is angled with respect to the longitudinal axis of the body 22 by a suitable angle, theta, which is preferably about 30-90 degrees. The distal end 24 of the body 22 is reduced in thickness and tapers outwardly toward the tip 28 such that the tip is wider than a substantial portion of the body 22. The inner surface of the tip 28 adjacent the end 30 includes a transverse shoulder 32.

The body 22 of the tool 20 may be formed of a hard rigid material, preferably metal such as, for example, a strip of iron, steel, or other metal having sufficient thickness for rigidity. Metal provides the necessary strength and is economical for manufacturing. Other suitable rigid materials may be used for the body 22 of the tool 20 including, for example, a rigid plastic.

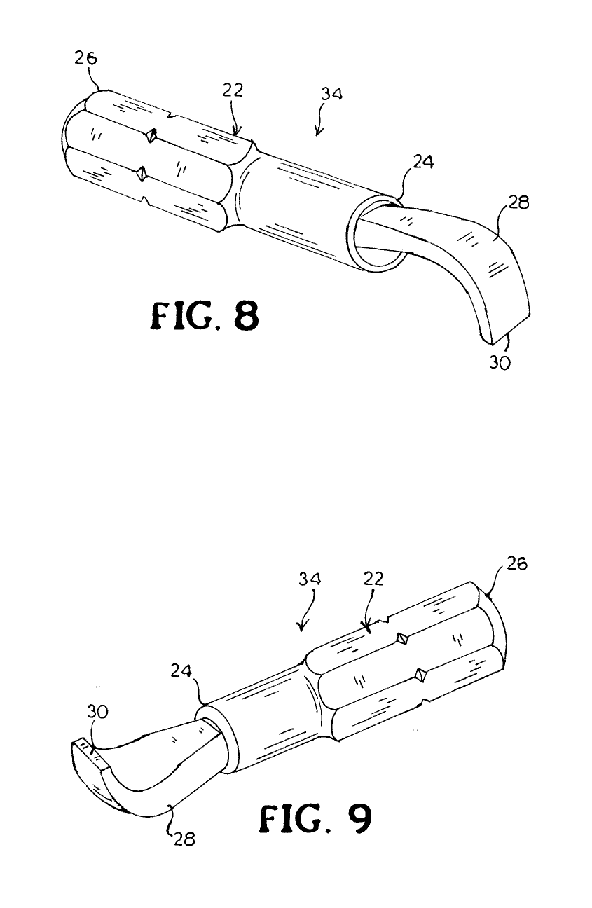

A second embodiment of a tool for removing a lid of a container is shown in FIGS. 8 and 9 and generally designated at 34. This second embodiment of the tool 34 does not include a shoulder on the surface inner of the tip 28.

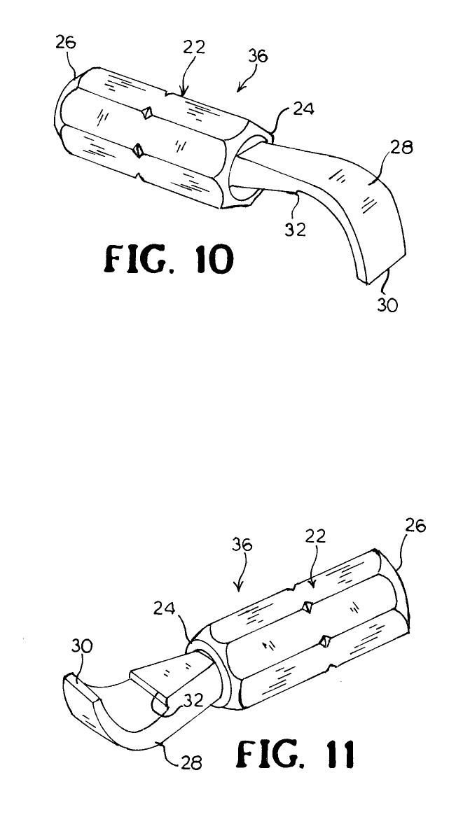

A third embodiment of a tool for removing a lid of a container is shown in FIGS. 10 and 11 and generally designated at 36. This third embodiment of the tool 36 comprises a shorter proximal end 26 of the body 22 than in the first embodiment 20.

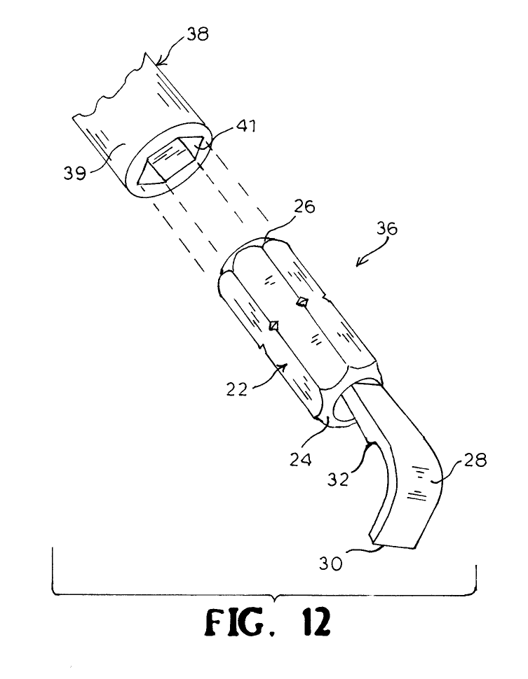

Referring now to FIG. 12, the tool 36 is shown in combination with an adaptor 38 for receiving the proximal end 26 of the tool 36. The adaptor 38 comprises a proximal shaft 37 and a distal grip (not shown). The shaft 39 comprises a thin, round elongated member. The end of the shaft 39 defines an opening 41, or socket, for receiving the proximal end 26 of the body 22 generally in line with the longitudinal axis of the tool 36. The shape of the socket 41 corresponds to the shape of at least the proximal end 26 of the body 22, such that the adaptor 39 and the tool 22 rotate together. In the embodiment shown, the proximal end 26 of the body 22 is hexagonal in transverse cross-section and fits non-rotationally within the hexagonal socket 41 of shaft 39. In one embodiment, the shaft 39, or a portion of the shaft, may be magnetic to provide a more secure coupling. The adaptor 38 may be formed from a rigid material, such as metal, wood or plastic.

The distal grip may extend from the shaft 39 a sufficient distance to enable a hand of a user to fit around the grip. The grip can be generally cylindrical, or may have another shape other than a simple cylinder. For instance, a cylindrical portion may include grip-enhancing ridges. In a further embodiment, the grip may comprise a rubberized covering to enhance handling. The grip is dimensioned to conveniently fit within the palm of a hand thereby optimizing use thereof.

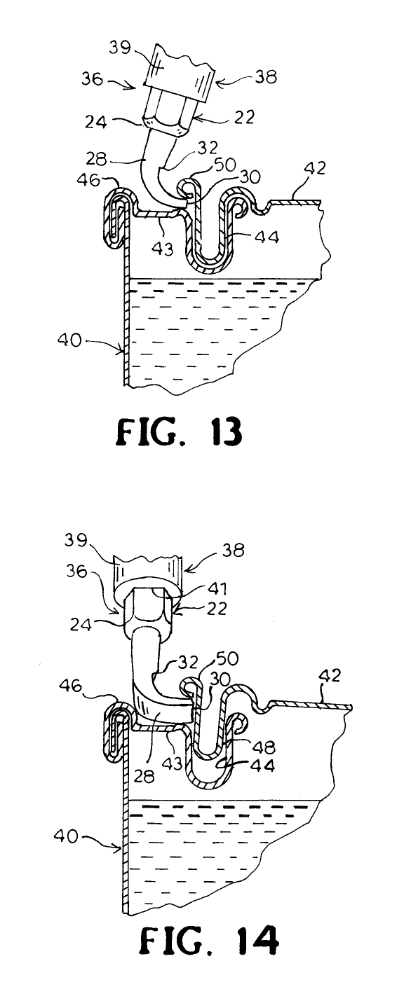

Referring now to FIGS. 13 and 14, a portion of a container 40 and a portion of a lid 42 of the container are shown with the tool 20 in position for opening the container 40 by removing the lid 42. In use, the curved tip 28 of the tool 20 terminating in a substantially sharp edge enables the tool to comprise means for removing the lid 42, such as a lid from a paint can. The tip 28 is configured to slip between the lip 50 of the lid 42 and the rim 43 of the container. The lid 42 is removed from the paint can 40 by inserting the edge of the tip 28 of the tool 20 into the gap between the lip 50 and the rim 43.

The user can grasp the grip in the same manner as the handle of a conventional tool, for example a screwdriver. Thereafter, the tool 20 is used as a lever and the rim 43 of the container as a fulcrum to impart a generally upward force on the lip 50 of the lid 42. The user holds the grip and exerts downward pressure radially of the container on the adaptor 38 and connected tool 20 to apply leverage force and thereby to enlarge the gap between the lid 42 and the rim 43 of the container 40. With enough force, the lip 50 of the lid 42 is disengaged from the rim 43 outwardly from the sealing channel 44 of the container. Subsequently, the tool 20 is moved along the circumference of the container while the tip 28 remains in the gap, and similar leverage force is applied to further open the gap between the lip 50 and the rim 43. The lid 42 is separated from the container 40, and the container is opened by repeating the leveraging motion as the user advances the tool 20 along the rim 43 of the container 40.

Although the present tool has been shown and described in considerable detail with respect to only a few exemplary embodiments thereof, it should be understood by those skilled in the art that I do not intend to limit the tool to the embodiments since various modifications, omissions and additions may be made to the disclosed embodiments without materially departing from the novel teachings and advantages of the tool, particularly in light of the foregoing teachings. Accordingly, I intend to cover all such modifications, omission, additions and equivalents as may be included within the spirit and scope of the tool as defined by the following claims. In the claims, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

I claim:

1. A tool for removing a lid from a container, the tool comprising:
a rigid elongated body member having a first end, a second end, and a longitudinal axis, the first end of the body member having an irregular perimeter;
a flange having a proximal end and a distal end, the proximal end of the flange being attached to the second end of the body member at a predetermined angle with respect to the longitudinal axis of the body member; and
a curved tip formed at the distal end of the flange, the curved tip terminating in a free distal edge, wherein the tip of the tool is adapted to engage the lid of the container for repeatedly applying leverage force to the lid for prying the lid from the container.

2. The tool as recited in claim 1, wherein the tip includes a flat portion intermediate the ends of the flange and extending transversely to the longitudinal axis of the body member, the flat portion for use as a cam surface.

3. The tool as recited in claim 1, wherein the distal edge of the tip extends in a direction approximately perpendicular to the longitudinal axis of the body member.

4. The tool as recited in claim 1, wherein the tip is tapered from the proximal end to the distal end such that the distal edge is thinner and wider than the proximal end of the tip.

5. The tool as recited in claim 1, wherein the body member, the flange and the tip are a unitary piece of material.

6. In combination:
a tool comprising
a rigid elongated body member having a first end, a second end, and a longitudinal axis, the first end of the body member having an irregular perimeter,
a flange having a proximal end and a distal end, the proximal end of the flange being attached to the second end of the body member at a predetermined angle with respect to the longitudinal axis of the body member, and
a curved tip formed at the second end of the flange and having a distal edge oriented in a direction substantially perpendicular to a plane defined by the longitudinal axis of the member; and
a handle member having an opening dimensioned to non-rotatably receive a portion of the first end of the body member;
wherein the tool is secured in the opening of the handle and the tip of the tool is adapted to engage the lid of the container such that the combined handle and tool repeatedly apply leverage force to the lid for prying the lid from the container.

7. The combination as recited in claim 6, wherein the tip includes a flat portion intermediate the ends of the flange and extending transversely to the longitudinal axis of the body member, the flat portion for use as a cam surface.

8. The combination as recited in claim 6, wherein the distal edge of the tip extends in a direction approximately perpendicular to the longitudinal axis of the body member.

9. The combination as recited in claim 6, wherein the tip is tapered from the proximal end to the distal end such that the distal edge is thinner and wider than the proximal end of the tip.

10. The combination as recited in claim 6, wherein the body member, the flange and the tip are a unitary piece of material.

11. The combination as recited in claim 6, further comprising gripping means formed on the handle member.
